(19) United States
(12) Patent Application Publication
(10) Pub. No.: US 2016/0183327 A1
(43) Pub. Date: Jun. 23, 2016

(54) DEVICE FOR HEATING A COMPOSITE MATERIAL WITH TEMPERATURE-DEPENDENT PROCESSING CHARACTERISTICS, AND ASSOCIATED METHODS

(71) Applicant: Airbus Defence and Space GmbH, Ottobrunn (DE)

(72) Inventors: Franz Engel, Munich (DE); Tilman Orth, Munich (DE); Christian Weimer, Munich (DE); Wolfgang Rehm, Hergensweiler (DE)

(21) Appl. No.: 14/978,533

(22) Filed: Dec. 22, 2015

(30) Foreign Application Priority Data
Dec. 22, 2014 (DE) 10 2014 018 934.1

(51) Int. Cl. H05B 3/00; B30B 15/34

(52) U.S. Cl. CPC H05B 3/0057; B30B 15/34

(57) ABSTRACT

A light emitting unit comprises at least one lighting means for emitting light (L) for heating a composite material, e.g. resin of a carbon fiber reinforced plastic, wherein the composite material can be fused and/or softened and/or cured, and/or be hold in a liquid state by the heating and wherein the emission of light (L) of the lighting means can be controlled differently in several areas. Furthermore, this relates to a method for producing a component made of the composite material as well as a method for producing the light emitting unit.

### CROSS-REFERENCE TO RELATED APPLICATIONS

This application claims priority to German Patent Application No. 10 2014 018 934.1, filed Dec. 22, 2014, which is incorporated herein by reference in its entirety.

### TECHNICAL FIELD

The present embodiment generally relates to a device for heating up a material comprised of at least two components, one component of which is softened by the heating, so that the entire material can be better shaped and joined and/or fused and/or hardened and/or kept liquid. In particular, the composite material can be a fiber-reinforced plastic (FVK), wherein the type of matrix material, whether it be thermoset or thermoplastic, determines the objective of heat treatment. In addition, the embodiment relates to a method for manufacturing the aforementioned device, and to a method for manufacturing a component, in particular out of a fiber composite material, with the use of the device.

### BACKGROUND

The devices and methods mentioned by way of introduction are used in particular during the so-called preforming and hardening of fiber composite components at an elevated temperature. The temperature of the component here has a major influence on the manufacturing process and quality of the end product. For this reason, it is of great interest that temperature control be as precise as possible and adjusted to the needs and requirements of the component. In particular lightweight components with a high degree of functional integration exhibit geometries which are locally significantly variable, e.g., with significantly variable wall thicknesses, or even materials, thus making it necessary to be able to locally adjust the temperature of the material or semi-finished component.

For example, known devices of the kind mentioned at the outset exhibit autoclaves or furnaces. However, the disadvantage to the latter in particular is that they are very expensive to procure and in continuous operation, and that the temperature of the material can only be locally adjusted to a very limited extent, if at all, by means of complicated, expensive and heatable tools, the behavior of which is thermally very sluggish.

### SUMMARY

A light-emitting unit according to an embodiment, hereinafter abbreviated LEE, exhibits at least one lighting device, in the following denoted as “lamp”, for emitting light to heat a composite material, wherein the material can be fused and/or softened and/or hardened and/or kept liquid by the heating, and wherein the light emitted by the lamp can be regionally variably controlled, or even especially preferably, regulated.

In particular, the LEE makes it possible to realize any temperature distributions in the material to be heated, be they homogeneous or heterogeneous, which can also be chronologically variable. A preferred exemplary application of the LEE involves heating the resin of a carbon fiber-reinforced plastic (CFK) as the matrix material, whose processing characteristics change with the temperature. Without being limited thereto, the embodiment will for the most part, unless otherwise specified, be described in the following based on this preferred exemplary application, even though in particular other (fiber-reinforced) plastics can advantageously also be regionally variably heated with the LEE according to the embodiment.

In particular, “regionally variably” must be understood to mean that the LEE can be divided into at least two regions that do not overlap. In these regions, the light emission of the at least one lamp can be controlled or regulated independently of each other, e.g., with respect to its light intensity or wavelength. It is especially preferred that the LEE also be set up to allow a chronologically independent control or regulation of the light emitted in the regions. It is especially preferred that the LEE exhibit at least two lamps, which are located in respectively different regions of the LEE described above, and can be controlled or regulated independently of each other in terms of their light emission in the manner described above.

The wavelength of the emittable light can lie in the visible, infrared or ultraviolet range. Depending on the requirements, the LEE is set up to heat up, fuse and/or soften and/or harden and/or keep liquid the resin in the CFK by sending out or emitting electromagnetic waves in the form of light with the at least one lamp, namely in particular variably in the at least two regions. Variably actuating the lamps enables the simultaneous or time-delayed emission of light in all or only in selected regions of the LEE. As a result, the CFK positionable in the area radiated by the lamp can on the one hand be radiated over its entire surface, and thus heated according to the embodiment when light is emitted in all regions of the LEE. However, in the event that light is only emitted in selected regions or light is emitted more intensively in one region than in another region, it is especially advantageous that specific regions or locations of the CFK can be specifically, locally and variably radiated, and hence heated. As a consequence, the LEE helps to tailor the process of heating the CFK specifically to its needs and requirements. For example, a region in which the CFK is present with a smaller material thickness can in this way be heated less intensively than a region in which the CKF is present with a larger material thickness.

In other words, this enables the targeted treatment of a (semi-finished) CFK component to be manufactured with locally variable heat inputs (e.g., for variable component thicknesses, component geometries) or the targeted treatment of flow paths. In addition, this enables a very simple and dynamic process regulation with controllable temperature profiles. Because heat can be introduced in a targeted manner where it is needed, and this can be done with the desired intensity, the LEE according to the embodiment is distinguished by an especially high energy efficiency level. In particular by comparison to the previously known, very sluggish autoclave or furnace processes, the LEE can be used to change the temperature of the CFK especially quickly. Furthermore, no fluids have to be handled, which reduces the equipment outlay and facilitates functional control.

In particular, the LEE is set up in the manner described above to drape CFK semi-finished products (prepregs) pre-impregnated with resin, whose deformability depends on the temperature, and which are placed in a tool for manufacturing a component out of CFK, in the tool or mold, fuse plastics (thermoplastics) in the tool, harden plastics (thermosets) in the tool, control the viscosity of a liquid plastic in the tool, preheat a resin-free semi-finished product in the tool before injecting the resin, and preheat the tool before placing in a finished or unfinished component.

A first embodiment provides that the lamps exhibit light-emitting diodes (LED's), whose light emissions can be controlled at least partially independently of each other. In particular, the use of LED's enables a very high energy efficiency, which especially allows a further reduction in operating costs. In prior art, in particular in an autoclave or furnace process, local so-called hotspots are encountered time and again. This can be avoided through the use of LED's. For example, the LED's can be applied flatly onto the LEE, and firmly attached thereto. In addition, the LED's can be situated in connectable modules, if necessary with corresponding supplementary components, or configured as networks.

Another embodiment provides that the lamps exhibit at least one light-emitting film, whose light emission is regionally controllable. In particular, the advantage to such a film is that it takes up especially little installation space, simplifies the manufacture of LEE's, and can be particularly simple and cost-effective in design. The film can be integrated as a separate LEE in a half-open or closed tool. In particular, the film can further encompass organic light-emitting diodes, and be placed, deep-drawn or pressed into a tool. A further advantage to the film is that a film typically provided in a tool and method or an aid can be replaced, which provides a vacuum or an infusion process.

It is further provided that the film be treated from one side in such a way that light is emitted in only one direction. This helps ensure that the light radiation can be used in an especially effective and efficient manner to heat up the material. In addition, it is advantageously provided that several light-emitting films be placed one on top of the other, making it possible to achieve an especially high intensity of the emitted radiation. Furthermore, a milky haze could also be imparted to the film, thereby enabling an especially uniform distribution of the emitted light, and a homogenization of the luminance with respect to the relatively small, local light sources. It is also advantageously provided that the film be configured in such a way as to exhibit optical properties with which the light can be converted into heat in an especially effective and efficient manner.

In another embodiment, the LEE can be part of an upper shell and/or lower shell of a tool for manufacturing a component out of the composite material. For example, if the LEE exhibits LED's, the latter can be integrated into the upper shell and/or the lower shell of the tool, or applied to the latter. If the LEE exhibits a light-emitting film of the kind described above, the latter can be applied as a layer to the upper shell and/or lower shell of the tool. The LEE can here be oriented and set up in such a way that its light emission, and hence also its thermal radiation, can be directed toward the respective other tool shell. In particular, this makes it possible to heat the respective other tool shell or CFK's located between the tool shells. In this conjunction, it is advantageously likewise provided that the LEE be oriented and set up in such a way that its light emission, and hence also its thermal radiation, can additionally or alternatively be directed toward the tool shell to which the LEE is allocated, meaning that it can heat its own upper shell or lower shell.

In addition, the LEE can be suitably positioned between the upper shell or lower shell of a tool and material located between the tool shells on the other hand, for which purpose the LEE need not be part of the tool shells.

The LEE can exhibit several LEE modules that can be interconnected and again separated. For example, the LEE modules can be positioned in an open tool above the material or on a substrate of the tool. The LEE modules can together comprise a mold, which in particular is variable. The LEE modules offer an especially flexible structural design for the LEE, which can be especially well adjusted to the needs and requirements of a component to be manufactured.

The LEE can further be set up to exert a compressive force on the composite material. To this end, the LEE can exhibit one or more stamps, which can be or are pressed onto the CFK in a targeted manner at specifically selected locations, so as to enable an especially high heat input and pressure in these regions.

In another embodiment, the lamps, especially preferably the LED's, are arranged outside of the tool, and can “pump” light into a film, upper shell or lower shell. In particular glass fibers or other light guiding materials an here form a reticular or octopus-like structure, in which light is emitted by the lamps. Such a structure can advantageously be positioned over the material to be heated, placed into the tool or integrated into a vacuum structure. It is especially preferably provided that the glass fibers or light guiding materials be made in such a way that the light can again exit the latter and hit the material to be heated. In this conjunction, in particular three advantageous variants are provided and described below.

In a first variant, the lamps are laterally situated next to the film, lower shell or upper shell, and set up to emit light into the film or lower shell or upper shell, wherein the film or lower shell or upper shell is set up to distribute and/or redirect the light in such a way that it can be radiated in the direction of composite material located in the tool. This variant makes it possible to position the lamps especially close to the film, lower shell or lower shell, especially preferably without any gap, which is advantageous in particular because only especially low heat conductivity losses arise.

In a second variant, the light from the lamps can be emitted into the film or lower shell or upper shell via glass fibers, and distributed and redirected according to the first variant. Other light-guiding materials can here be used instead of glass fibers. What is important is that the glass fibers or other light-guiding materials separate or decouple the lamp and radiated element from each other, which in particular simplifies the cooling of the LEE.

In a third variant, the lamps are arranged above the film or upper shell, and set up to emit light into the film or upper shell via a plurality of glass fibers, so that light can be radiated in the direction of composite material located inside of the tool. The light, in particular of LED's, can thereby be coupled into the film or upper shell from above through several points by way of an octopus-like structure of glass fibers, and distributed by way of a hazy film, for example. In addition, deflection according to the first variant becomes unnecessary if the glass fibers emit the light in an orientation already suitable for radiating the material. Just as in the second variant, suitable light-guiding materials other than the glass fibers can be used in the third variant as well.

In particular, it can further be provided that the LEE exhibit at least one temperature sensor for regionally acquiring the temperatures of a composite material in the tool or the at least one lamp, and that a control unit be provided, which is set up to control or regulate the light emission of the at least one lamp as a function of the temperatures acquirable by the temperature sensor. This embodiment in particular makes it possible to automate and monitor temperature control.

The method according to the embodiment for manufacturing a component out of a composite material encompasses the following steps providing a composite material, in particular the resin of a CFK, for manufacturing the component providing a light-emitting unit (LEE) according to the embodiment described above; emitting light in a regionally variable manner by correspondingly controlling the at least one lamp, preferably two lamps, in a respective variable region of the LEE described further above, so that the composite material is regionally variably heated up.

When implementing the method, it can advantageously be provided that either a distance be maintained between the lamp and material to be heated, or that both be spaced apart from each other by a transparent protective layer, e.g., made out of glass or plastic. In the variant with the protective layer, a pressure could also be advantageously built up on the material. In addition, the LEE could also be positioned directly on the material to be heated up, without a tool being required, and suctioned thereto by generating a vacuum, similarly to a film used in a vacuum process. For example, the intensity of light emission can be controlled in an especially simple embodiment by directly applying a voltage to the LEE or through induction. It is likewise possible to automate the control process, and have it be performed by a control unit loaded with a corresponding computer program.

An embodiment of the inventive method according claim 12 further encompasses the following procedural steps: providing a temperature sensor of the kind described above and a control unit; regionally acquiring temperatures of the composite material in the tool or lamp by means of the temperature sensor, generating corresponding temperature values and transmitting them to the control unit; and regionally variably controlling or regulating the light emission of the lamps by means of the control unit as a function of the received temperature values.

In order to be able to set the temperature of the material in a regionally variable manner, either the temperature of the material itself is measured and used as a control parameter or variable, or the temperature of the at least one lamp, e.g., of two LED's, which are situated in different areas of the LEE. In the second alternative, the temperature of the material in the area of the respective LED is derived from the temperature of the respective lamp.

With respect to additional embodiments and advantages of the method according to the embodiment, reference is made to the statements in conjunction with the LEE according to the embodiment so as to avoid repetition.

The inventive method is used to manufacture a light-emitting unit in a tool, and is characterized by the application of at least one light-emitting layer to the tool, so that the layer can emit light in a regionally variable manner in the direction of the composite material that can be introduced into the tool. The layer can be used as an alternative to the lamps described above, and be fabricated, for example, through vapor deposition, dusting, tool mold insertion, painting, sputtering, molecular beam epitaxy or galvanization. Several layers capable of regionally variably emitting light can also be applied one on top of the other in several passes.

### BRIEF DESCRIPTION OF THE DRAWINGS

The various embodiments will hereinafter be described in conjunction with the following drawing figures, wherein like numerals denote like elements, and:

FIG. 1 is a schematic front view of an exemplary embodiment of a light-emitting unit (LEE) according to the embodiment;

FIG. 2 is a schematic perspective view of the LEE according to FIG. 1 on another scale, and

FIG. 3 are various additional exemplary embodiments of a light-emitting unit.

FIG. 4 are various additional exemplary embodiments of a light-emitting unit.

FIG. 5 are various additional exemplary embodiments of a light-emitting unit.

FIG. 6 are various additional exemplary embodiments of a light-emitting unit.

FIG. 7 are various additional exemplary embodiments of a light-emitting unit.

FIG. 8 are various additional exemplary embodiments of a light-emitting unit.

FIG. 9 are various additional exemplary embodiments of a light-emitting unit.

### DETAILED DESCRIPTION

The following detailed description is merely exemplary in nature and is not intended to limit the disclosed embodiments or the application and uses thereof. Furthermore, there is no intention to be bound by any theory presented in the preceding background detailed description.

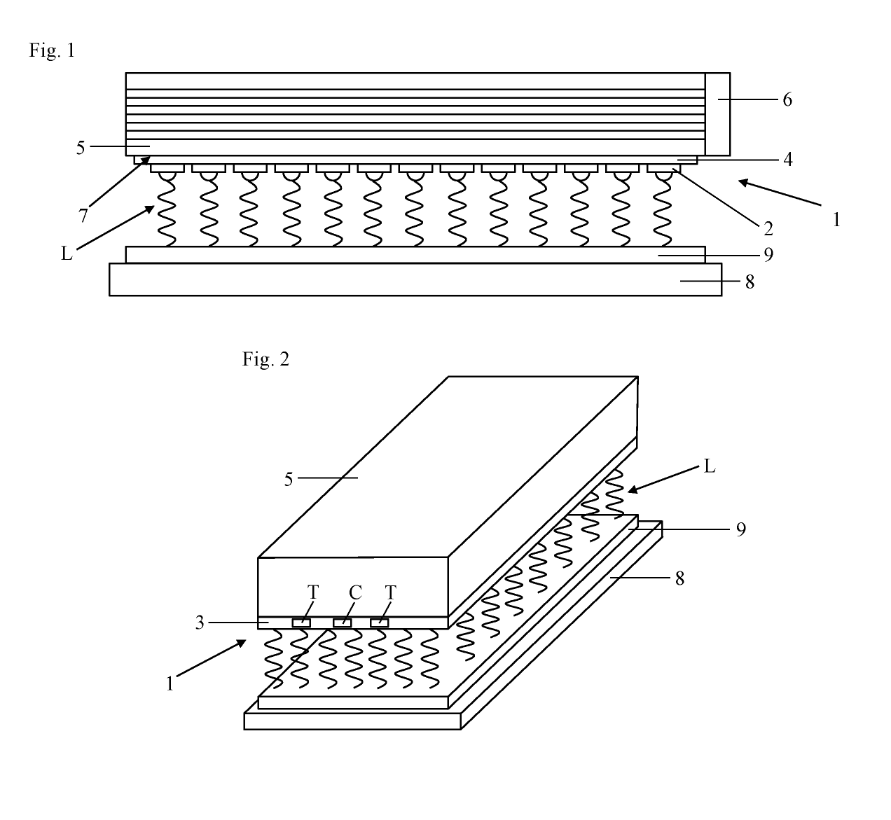

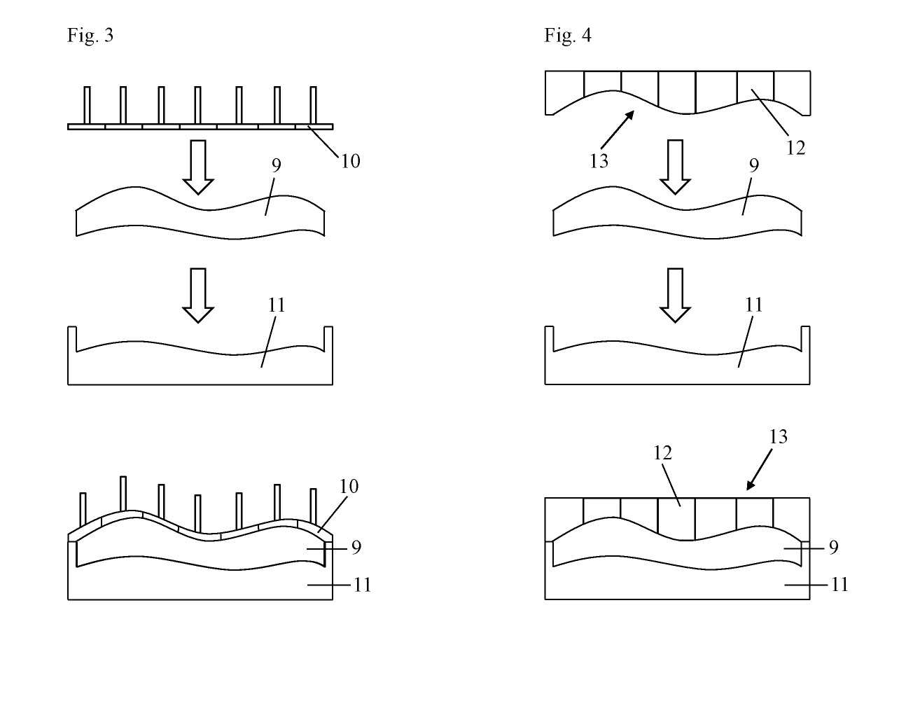

FIGS. 1 and 2 show an exemplary embodiment of an LEE 1 which exhibits a plurality of lamps in the form of a plurality of light-emitting diodes (LED's) 2, which are arranged side by side, combined into an LED array 3. The emitted light L is represented by the wavy lines on FIGS. 1 and 2.

The LED array 3 exhibits a carrier board 4 with terminals, and is fixedly secured to the lower side of a heat sink 5, through which flows air that cools the LED array 3. The cooling air is aspirated by a fan 6, moved through the heat sink 5 and blown out again on the side opposite the fan 6. Situated between the LED array 3 and heat sink 5 is a layer comprised of a heat-conducting paste 7, which facilitates thermal transfer between the LED array 3 and heat sink 5.

The LED's 2 can be actuated individually and independently of each other by means of a control unit C arranged in the LED array 3 via communication lines (not shown) in such a way that they can emit light of varying intensity, so that a composite material 9 in the form of a laminate present on a board 8 underneath the LED array 3 can be heated up in a regionally variable manner. The control unit C here receives temperature values from temperature sensors T, which are also arranged in the LED array 3, connected with the control unit C via communication lines (not shown), and positioned and set up in such a way that temperatures are measured in the area of a selected LED and corresponding measured values can be generated. Even though the LEE 1 encompasses a plurality of the mentioned temperature sensors T, only two temperature sensors T are shown for the sake of clarity, which each are allocated to one area of the LEE 1. The measured values can be relayed to the control unit C via the communication lines. The control unit C can have loaded into it a computer program, with which the light emission of the LED's, in particular those LED's from which a temperature value was received, can be controlled and especially preferably regulated, wherein the control unit allocates to the received temperature values those temperatures of the laminate in the area of the LED where the temperature was measured by the temperature sensor T.

FIGS. 3 to 9 show the respective material that softens or fuses when exposed to temperature, in the form of a resin of a carbon fiber-reinforced plastic (CFK) that is heated up.

FIG. 3 here shows a total of seven stamps 10 arranged side by side, which each are fitted with an LEE (not shown) (upper part of FIG. 3), wherein the material 9 that was provided in a lower shell 11 of a tool for manufacturing a component out of the material 9 is extensively or locally radiated and optionally compacted (lower part of FIG. 3). To this end, for example, the stamps 10 exhibit hydraulic elements or actuators (not shown). In addition, those areas of the stamps 10 that can come into contact with the material 9 or lower shell 11 are designed in such a way that they can adjust to the contour of the material 9 or lower shell 11 and exert a compressive force on the latter.

FIG. 4 shows several side by side LEE modules 12 that can be interconnected and again separated, which each are fitted with an LEE (not shown) and fixedly joined together to yield a solid upper shell 13 of the tool. The LEE's are moved toward the material 9, specifically to the point where the latter is contacted (lower part of FIG. 4). Alternatively, a gap not shown on FIG. 4 can remain between the LEE and material 9, or a transparent layer (not shown) could be arranged between the LEE and material 9.

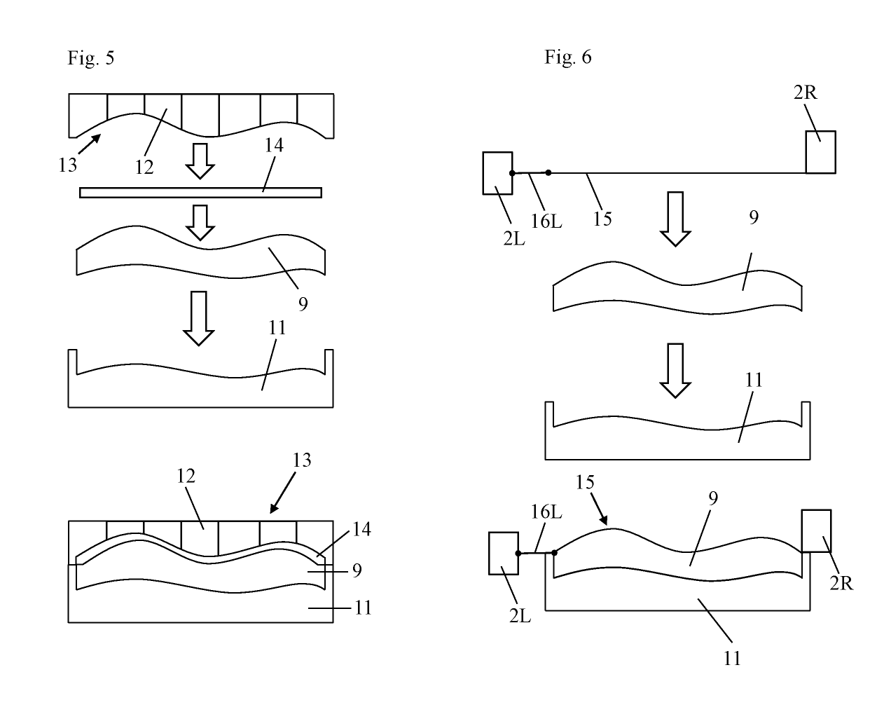

FIG. 5 differs from FIG. 4 in that a film 14 is situated between the LEE and material 9, which was slipped onto the material 9 by generating a vacuum between the material 9 and LEE. Alternatively, the film 14 can also be slipped onto the upper shell 13 of the tool.

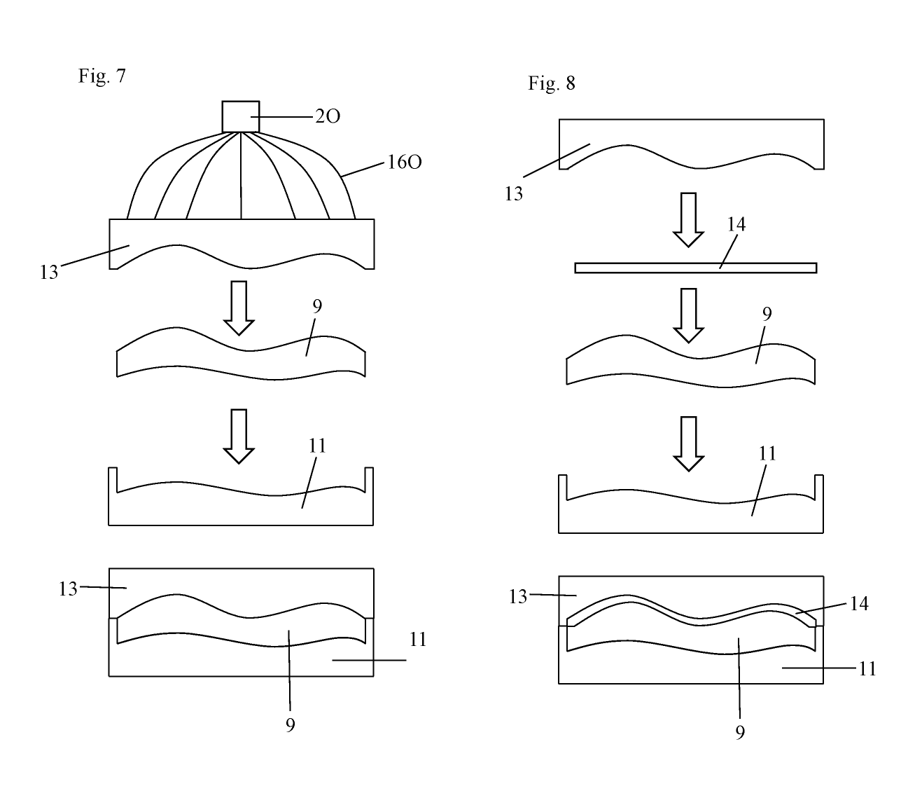

FIG. 6 shows an LEE 1, which exhibits a light-emitting film (LEF) 15, which is slipped onto the material 9 by generating a vacuum between the film 15 and material 9 (lower part of FIG. 6). A network of LED's (not shown) can also be provided instead of the film 15. FIG. 6 also shows that LED's can guide light into the film 15 directly or indirectly via glass fibers, in which the light is extensively distributed by suitable means (not shown) and diverted in such a way that it can hit the material 9 and heat it up. The LED 2R shown on the right side of FIG. 6 is laterally arranged without a gap next to the film, and guides the light directly into the film 15. By contrast, the LED 2L shown on the left side of FIG. 6 is laterally arranged with a gap next to the film 15, emits light and guides it via a glass fiber 16L into the film 15, in which it is distributed and redirected as described above. FIG. 7 differs from FIG. 4 in that a single upper shell 13 is depicted, which does not consist of individual LEE modules 12. In addition, an LED 2O is situated above the upper shell 13, and guides the light emitted from the LED 20 via a bundle of glass fibers 16O resembling an octopus into the upper shell 13, so that light can be radiated in the direction of the material 9.

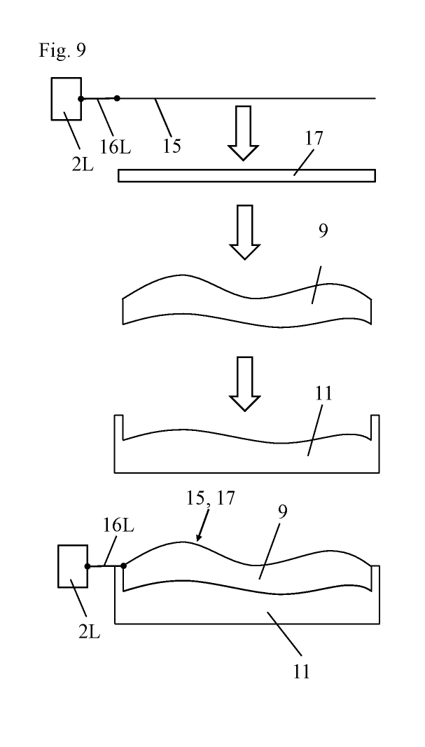

FIG. 8 differs from FIG. 5 in that a single upper shell 13 is depicted, which does not consist of LEE modules 12.

FIG. 9 differs from FIG. 6 in particular in that the right LED 2R is omitted, and a conventional film 17 for a VAP process is slipped between the light-emitting film 15 and material 9.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the embodiment in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the embodiment as set forth in the appended claims and their legal equivalents.

1. A light-emitting unit (LEE) comprising:
at least one lamp for emitting light (L),
a composite material for being heated by the light (L),
wherein the material can be fused and/or softened and/or hardened and/or kept liquid by the heating, and
wherein the light emitted by the at least one lamp can be regionally variably controlled.

2. The LEE according to claim 1, wherein the lamp(s) exhibits light-emitting diodes (LED's), whose light emissions can be controlled at least partially independently of each other.

3. The LEE according to claim 1, wherein the lamps(s) exhibits at least one light-emitting film (LEF), whose light emission is regionally controllable.

4. The LEE according to claim 3, wherein the LEF is treated from one side in such a way that light (L) is emitted in only one direction.

5. The LEE according to claim 1, wherein the LEE is part of an upper shell and/or lower shell of a tool for manufacturing a component from composite material.

6. The LEE according to claim 1, wherein the LEE exhibits several LEE modules that can be interconnected and again separated.

7. The LEE according to claim 1, wherein the LEE is configured to exert a compressive force on the composite material.

8. The LEE according to claim 5, wherein the lamps(s) are laterally situated next to a film, lower shell or upper shell, and set up to emit light into the film or lower shell or upper shell, wherein the film or lower shell or upper shell is configured to distribute and/or redirect the light in such a way that it can be radiated in the direction of composite material located in the tool.

9. The LEE according to claim 8, wherein the light from the lamp(s) (2L) can be emitted into the film or lower shell or upper shell via glass fibers (16L).

10. The LEE according to claim 5, wherein the lamp(s) (2O) are arranged above the film or upper shell, and configured to emit light into the film or upper shell via a plurality of glass fibers (16O), so that light can be radiated in the direction of composite material located inside of the tool.

11. The LEE according to claim 5, wherein the LEE exhibits at least one temperature sensor (T) for regionally acquiring the temperatures of a composite material in the tool or the at least one lamp, and wherein a control unit (C) is provided, which is configured to control or regulate the light emission of the at least one lamp as a function of the temperatures acquirable by the temperature sensor (T).

12. A method for manufacturing a component out of a composite material, comprising:
providing a composite material for manufacturing the component;
providing a light-emitting unit (LEE); and
emitting light (L) in a regionally variable manner by correspondingly controlling the at least one lamp, so that the composite material is regionally variably heated up.

13. The method according to claim 12, wherein
a temperature sensor (T) and a control unit (C), LEE exhibits at least one temperature senor (T) for regionally acquiring the temperatures of a composite material in the tool or the at least one lamp, and wherein a control unit (C) is provided, which is configured to control or regulate the light emission of the at least one lamp,
wherein the LEE exhibits at least one temperature sensor (T) for regionally acquiring the temperatures of a composite material in the tool or the at least one lamp, and wherein a control unit (C) is provided, which is configured to control or regulate the light emission of the at least one lamp as a function of the temperatures acquirable by the temperature sensor (T), wherein
temperatures of the composite material in the tool or lamp are acquired by means of the temperature sensor (T), and corresponding temperature values are generated and transmitted to the control unit (C), and
the light emission of the lamp(s) is regionally variably controlled or regulated by means of the control unit (C) as a function of the received temperature values.

14. A method for manufacturing a light-emitting unit (LEE) in a tool, wherein at least one light-emitting layer is applied to the tool, so that the layer can regionally variably emit light in the direction of the composite material that can be introduced into the tool.
